(19) United States
(12) Patent Application Publication
(10) Pub. No.: US 2008/0272994 A1
(43) Pub. Date: Nov. 6, 2008

(54) APPARATUS FOR CONTROLLING THE LIQUID CRYSTAL DISPLAY

(75) Inventors: Hsiang-Chih Chen, Taipei City (TW); Tsung-Hsing Hu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/781,278

(22) Filed: Jul. 23, 2007

(30) Foreign Application Priority Data
May 3, 2007 (TW) 96115702

(51) Int. Cl. G09G 3/36

(52) U.S. Cl. 345/87

(57) ABSTRACT

An apparatus for controlling an LCD is provided. The apparatus includes a memory, an image scaler circuit, a liquid crystal accelerating circuit, an image stretcher circuit, and an interface signal transmitting circuit. A first frame data is stored in the memory. The image scaler circuit receives and shrinks a second frame data. The liquid crystal accelerating circuit is coupled to the image scaler circuit, the memory, and the image stretcher circuit for comparing the first and the second frame data and adjusting pixels of the second frame data. The apparatus refreshes the first frame data stored in the memory with the second frame data. The image stretcher circuit enlarges the adjusted second frame data, and transmits an interface signal to a liquid crystal panel module through the interface signal transmitting circuit. The present invention drives the liquid crystal panel module to achieve the output maximum resolution with minimum required memory.

### CROSS-REFERENCE TO RELATED APPLICATION

This application claims the priority benefit of Taiwan application serial no. 96115702, filed May 3, 2007. All disclosure of the Taiwan application is incorporated herein by reference.

### BACKGROUND OF THE INVENTION

1. Field of the Invention

The present invention relates to an apparatus for controlling a liquid crystal display (LCD). More particularly, the present invention relates to an apparatus for controlling the LCD reducing required memory, capable of reducing bandwidth used by the memory and reducing power consumption.

2. Description of Related Art

Referring to FIG. 1, a circuit block diagram of a conventional LCD control system is shown. An apparatus 100 for controlling the LCD is used to drive a LCD panel module 110. A liquid crystal accelerating circuit 104 is coupled between an image scaler and stretcher circuit 102 and an interface signal transmitting circuit 106. The liquid crystal accelerating circuit 104 adjusts an input of each frame data, for improving response time of liquid crystal molecules, reducing motion blur caused by dynamic image display, so as to obtain fluent dynamic image display.

The liquid crystal accelerating circuit 104 is used together with a memory 108. A preceding frame data is stored in the memory 108 for comparing with the following frame data to determine pixel data of accelerating liquid crystal twist. The adjusted frame data is transmitted and displayed on a liquid crystal panel module. The quantity and used bandwidth of the memory 108 required by the liquid crystal accelerating circuit 104 are different in accordance with the influence of the panel resolution. For example, two panel modules with different resolutions are driven, the resolution of one panel is 800*600, and the other is 1024*768, and the quantity of the memory required by the latter one is larger than the former one.

When the resolution of the liquid crystal panel driven by the conventional apparatus 100 for controlling the LCD increases, the required quantity of the memory 108 increases in proportion. Therefore, the cost and used bandwidth of the memory 108 are both increased, and the power consumption is further increased and thereby increases the operating temperature of the apparatus.

### SUMMARY OF THE INVENTION

Accordingly, the present invention is directed to an apparatus for controlling the LCD. A liquid crystal accelerating circuit and a memory are positioned between an image scaler circuit and an image stretcher circuit, and the required memory is smaller, so as to support relatively high liquid crystal panel resolution output.

The present invention further provides an apparatus for controlling the LCD, a liquid crystal accelerating circuit and a memory are positioned before the image scaler and stretcher circuit to reduce the required memory, so as to further reduce the bandwidth requirement, the memory cost, and the power consumption.

An apparatus for controlling the LCD including a memory, an image scaler circuit, a liquid crystal accelerating circuit, an image stretcher circuit, and an interface signal transmitting circuit is provided. The memory is employed to store a first frame data. The image scaler circuit is employed to receive a second frame data to shrink the second frame data accordingly. The liquid crystal accelerating circuit is coupled between the image scaler circuit, the image stretcher circuit, and the memory, for comparing the first frame data and the second frame data and adjusting pixels of the second frame data accordingly. The apparatus for controlling the LCD refreshes the first frame data stored in the memory with the second frame data. The image stretcher circuit is coupled to the liquid crystal accelerating circuit, for receiving and enlarging the adjusted second frame data. The interface signal transmitting circuit is used to receive the second frame data transmitted by the image stretcher circuit and outputs an interface signal to a liquid crystal panel module.

According to an embodiment of the present invention, the apparatus for controlling the LCD further includes an analog-to-digital interface for receiving an analog image signal, converting it to the second frame data accordingly, and transmitting the second frame data to the image scaler circuit.

The present invention also provides an apparatus for controlling the LCD including a memory, a liquid crystal accelerating circuit, an image scaler and stretcher circuit, and an interface signal transmitting circuit. The memory is used to store a first frame data. The liquid crystal accelerating circuit is coupled to the memory and the image scaler and stretcher circuit for receiving a second frame data, comparing the first frame data and the second frame data, and adjusting pixels of the second frame data accordingly. The apparatus for controlling the LCD refreshes the first frame data stored in the memory with the second frame data. The image scaler and stretcher circuit receives the second frame data adjusted by the liquid crystal accelerating circuit, so as to shrink or enlarge the second frame data accordingly. The interface signal transmitting circuit receives the second frame data transmitted by the image scaler and stretcher circuit, and outputs an interface signal to a liquid crystal panel module.

According to an embodiment of the present invention, the liquid crystal accelerating circuit and the memory are coupled between the image scaler circuit and the image stretcher circuit, or the liquid crystal accelerating circuit and the memory are coupled before the image scaler and stretcher circuit to reduce the problems due to the limitation of the memory capacity by the panel resolution as in the case of the prior art. Therefore, the memory required by the liquid crystal accelerating circuit is reduced, and the cost and bandwidth of the memory are reduced thereby reducing the power consumption of the memory and reduce the possibility of increasing the operating temperature of the apparatus.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block diagram of a conventional LCD control system.

FIGS. 2(a) to 2(c) are circuit block diagrams of an apparatus for controlling the LCD according to various embodiments of the present invention.

FIGS. 3(a) to 3(c) are circuit block diagrams of an apparatus for controlling the LCD according to various embodiments of the present invention.

FIGS. 4(a) and 4(b) are structural views of the arrangement of dies of an LCD controller integrated circuit (IC) according to an embodiment of the present invention.

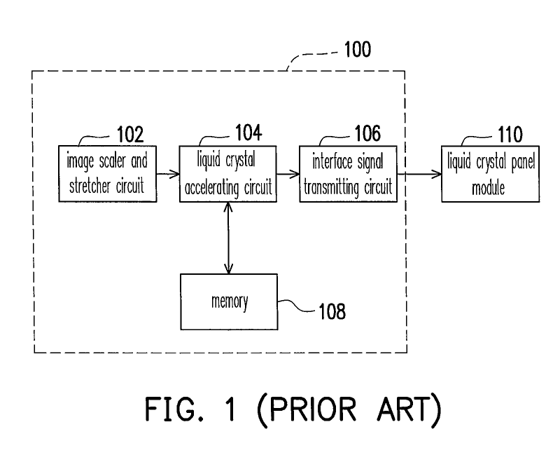

### DESCRIPTION OF EMBODIMENTS

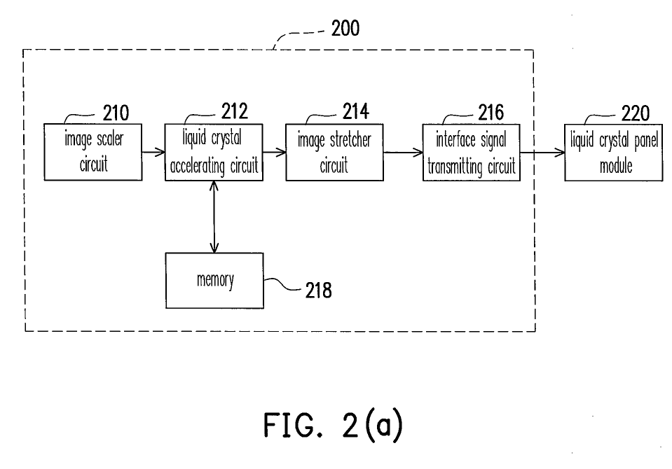

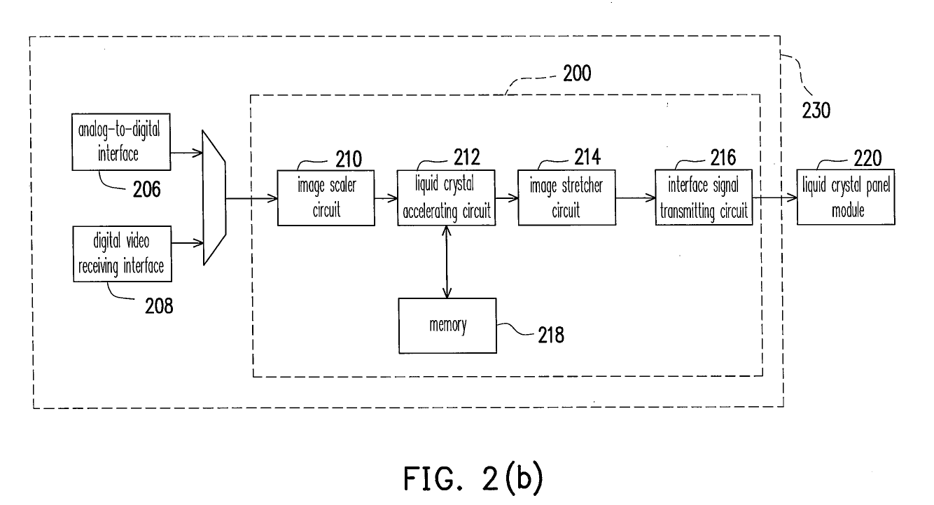

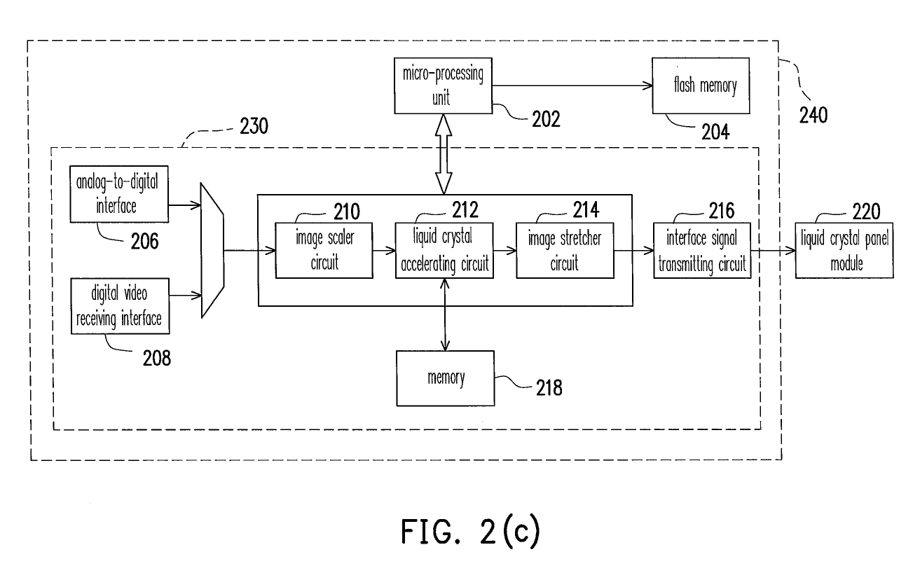

Referring to FIG. 2(a), a circuit block diagram of an apparatus 200 for controlling the LCD according to an embodiment of the present invention is shown. The apparatus 200 for controlling the LCD includes a memory 218, an image scaler circuit 210, a liquid crystal accelerating circuit 212, an image stretcher circuit 214, and an interface signal transmitting circuit 216. The apparatus 200 for controlling the LCD outputs an interface signal to a liquid crystal panel module 220 after receiving a frame data. The liquid crystal accelerating circuit 212 is coupled between the image scaler circuit 210, the image stretcher circuit 214 and the memory 218. The image stretcher circuit 214 is coupled to the liquid crystal accelerating circuit 212. The interface signal transmitting circuit 216 is coupled to the image stretcher circuit 214.

In the present embodiment, the memory 218 is used to store a first (preceding) frame data, the image scaler circuit 210 is used to receive a second (current) frame data, so as to shrink the second frame data accordingly. The liquid crystal accelerating circuit 212 compares the first frame data and the second frame data to determine the pixel of accelerating the liquid crystal twist, so as to adjust the pixels of the second frame data accordingly and transmit the adjusted second frame data to the image stretcher circuit 214. The apparatus 200 for controlling the LCD refreshes the first frame data originally stored in the memory 218 according to the second frame data. Next, the image stretcher circuit 214 receives and enlarges the adjusted second frame data. Next, the interface signal transmitting circuit 216 receives the second frame data, and transmits the interface signal with a suitable voltage to the liquid crystal panel module 220, so as to increase a particular liquid crystal twist voltage, and make the liquid crystal twist or restore more quickly to eliminate ghost. The interface signal can be a low voltage differential signal or a low amplitude differential signal.

The image scaler circuit 210 shrinks the image data, so that the quantity of the memory 218 required by the liquid crystal accelerating circuit 212 does not take the maximum resolution of the liquid crystal panel module 220 into account. Therefore, when the apparatus 200 for controlling the LCD is used to drive different liquid crystal panel modules, it is not necessary to change the quantity of the memory 218 in proportion to the maximum resolution of different panels, so the used quantity of the memory 218 is saved, and the bandwidth required by the memory 218 is saved. In this manner, the apparatus 200 for controlling the LCD is flexible to use the smallest memory to achieve the output effect in accordance with different panel resolutions and can reduce the power consumption of the entire system.

Referring to FIG. 2(b), a circuit block diagram of the apparatus 230 for controlling the LCD of an embodiment of the present invention is shown. In addition to the apparatus 200 for controlling the LCD, the apparatus 230 for controlling the LCD further includes an analog-to-digital interface 206 and a digital video receiving interface 208. The method of transmitting the second frame data to the image scaler circuit 210 is described as follows. The analog-to-digital interface 206 receives an analog image signal, converts it to the second frame data, and transmits the second frame data to the image scaler circuit 210 by using a multiplexer. Or, the digital video receiving interface 208 receives the digital image signal, converts it to the second frame data, and transmits the second frame data to the image scaler circuit 210 by the multiplexer.

Referring to FIG. 2(c), a circuit block diagram of the apparatus 240 for controlling the LCD of an embodiment of the present invention is shown. In addition to the apparatus 230 for controlling the LCD of FIG. 2(b), the apparatus 240 for controlling the LCD further includes a micro-processing unit 202 and a flash memory 204. Therefore, if the liquid crystal panel module 220 is changed, the apparatus 240 for controlling the LCD is flexible to use the smallest memory to achieve the output effect in accordance with different resolutions. In this embodiment, the micro-processing unit 202 controls the apparatus 230 for controlling the LCD, and the flash memory 204 stores an access control instruction satisfying the micro-processing unit 202. Even if the power source is turned off, the data stored in the flash memory 204 will not be lost.

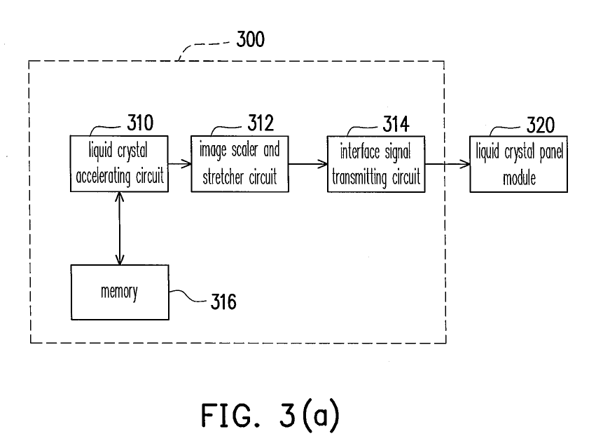

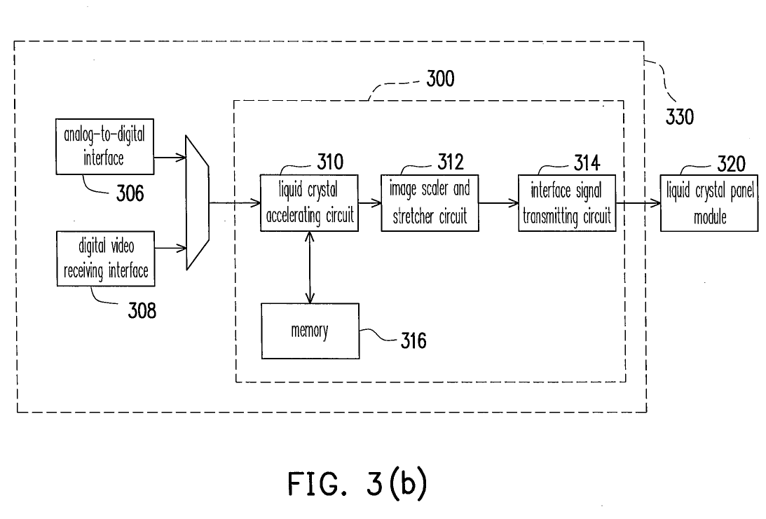

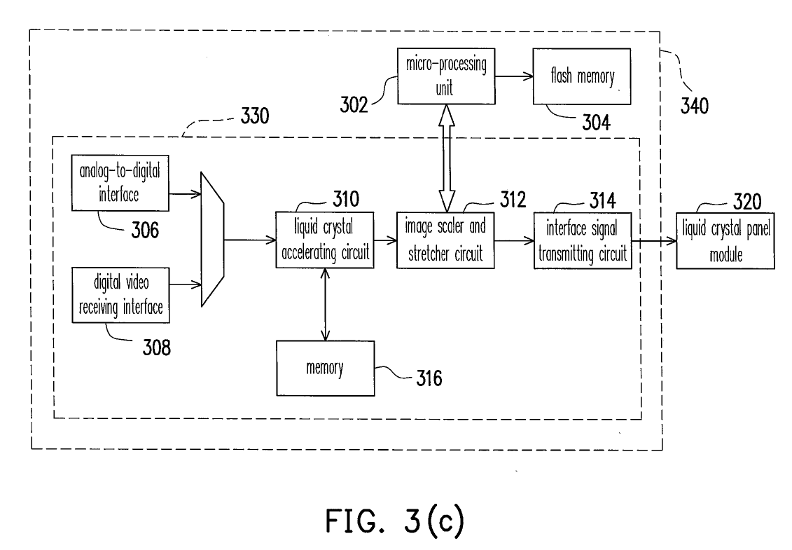

Referring to FIG. 3(a), a circuit block diagram of the apparatus 300 for controlling the LCD according to an embodiment of the present invention is shown. The apparatus 300 for controlling the LCD includes a memory 316, a liquid crystal accelerating circuit 310, an image scaler and stretcher circuit 312, and an interface signal transmitting circuit 314. The apparatus 300 for controlling the LCD receives the frame data and outputs an interface signal to the liquid crystal panel module 320. The liquid crystal accelerating circuit 310 is coupled between the image scaler and stretcher circuit 312 and the memory 316. The interface signal transmitting circuit 314 is coupled to the image scaler and stretcher circuit 312.

In the apparatus 300 for controlling the LCD, the memory 316 is used to store a first (preceding) frame data, the liquid crystal accelerating circuit 310 receives a second (current) frame data, compares the first frame data and the second frame data, and determines the pixel of accelerating the liquid crystal twist, so as to adjust the pixel of the second frame data and to transmit the adjusted second frame data to the image scaler and stretcher circuit 312. The apparatus 300 for controlling the LCD refreshes the first frame data originally stored in the memory 316 with the second frame data. Next, the image scaler and stretcher circuit 312 receives, shrinks/enlarges the adjusted second frame data. Next, the interface signal transmitting circuit 314 receives the second frame data, and transmits the interface signal with the suitable voltage to the liquid crystal panel module 320, so as to increase the particular liquid crystal twist voltage, and make the liquid crystal twist or restore more quickly to eliminate ghost. The interface signal may be a low voltage differential signal or a low amplitude differential signal.

The frame data received by the liquid crystal accelerating circuit 310 is not shrunk or enlarged, so the quantity of the memory 316 required by the liquid crystal accelerating circuit 310 does not take the maximum resolution of the liquid crystal panel module 320 into account. Therefore, the required memory in proportion to the panel maximum resolution is not required, so the bandwidth required by the memory 316 is saved. In this manner, the apparatus 300 for controlling the LCD is flexible to use smaller memory to achieve the output effect and reduce the power consumption of the entire system in accordance with different panel resolutions.

Referring to FIG. 3(b), a circuit block diagram 330 of the apparatus for controlling the LCD according to an embodiment of the present invention is shown. In addition to the apparatus 300 for controlling the LCD, the apparatus 330 for controlling the LCD further includes an analog-to-digital interface 306 and a digital video receiving interface 308. The method of transmitting the second frame data to the liquid crystal accelerating circuit 310 is described as follows. The analog-to-digital interface 306 receives an analog image signal, converts it to the second frame data, and transmits the second frame data to the liquid crystal accelerating circuit 310 by a multiplexer. Or, the digital video receiving interface 308 receives the digital image signal, converts it to the second frame data, and transmits the second frame data to the liquid crystal accelerating circuit 310 by the multiplexer.

Referring to FIG. 3(c), a circuit block diagram of the apparatus 340 for controlling the LCD of an embodiment of the present invention is shown. In addition to the apparatus 330 for controlling the LCD of FIG. 3(b), the apparatus 340 for controlling the LCD further includes a micro-processing unit 302 and a flash memory 304. Therefore, according to different resolution adjustment, the smaller memory can be used to achieve the output effect of the same resolution. In this embodiment, the micro-processing unit 302 controls the apparatus 330 for controlling the LCD, and the flash memory 304 stores an access control instruction satisfying the micro-processing unit 302. Even if the power source is turned off, the data stored in the flash memory 304 will not be lost.

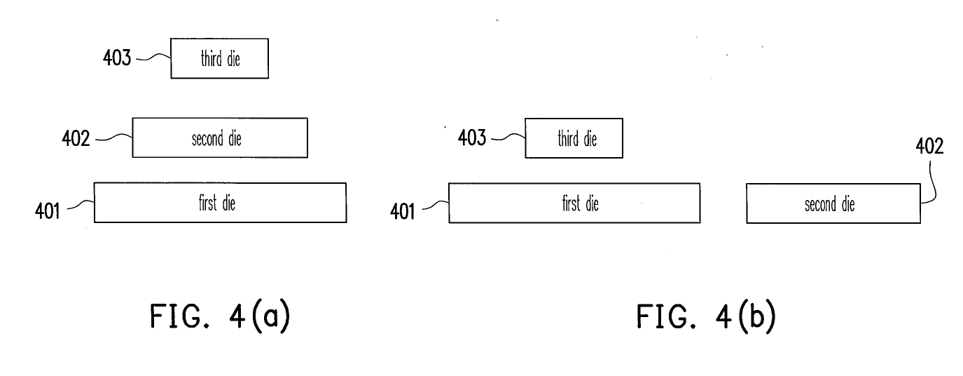

FIGS. 4(a) and 4(b) are structural views of the arrangement of dies of an LCD controller IC according to an embodiment of the present invention. In the above embodiment, the circuit elements represented by each die in FIGS. 4(a) and 4(b) are described as follows. First, taking the apparatus 240 for controlling the LCD of the above embodiment as an example, a first die 401 includes the image scaler circuit 210, the liquid crystal accelerating circuit 212, the image stretcher circuit 214, the interface signal transmitting circuit 216, and the micro-processing unit 202. A second die 402 includes the memory 218. A third die 403 includes the flash memory 204. If the apparatus 340 for controlling the LCD is set as an example, the first die 401 includes the liquid crystal accelerating circuit 310, image scaler and stretcher circuit 312, and interface signal transmitting circuit 314, and micro-processing unit 302. The second die 402 includes the memory 316. The third die 403 includes the flash memory 304.

In FIG. 4(a), the structural arrangement of the first die 401, the second die 402, and the third die 403 is, for example, a pyramid type formed by means of stacking, so as to form a packaged IC. In this embodiment, as shown in FIGS. 4(a) or 4(b), a plurality of dies is integrated into a single package, and all the circuits of the apparatus are integrated accordingly, so as to effectively reduce the cost incurred due to, for example the additional packaging cost and wiring cost. Thus, the number of the elements on the printed circuit board may be effectively reduced and utilization of area on the printed circuit board may also be reduced.

As can be known from the illustration of the above embodiments of the apparatus for controlling the LCD, the liquid crystal accelerating circuit and the memory are coupled between the image scaler circuit and the image stretcher circuit, or the liquid crystal accelerating circuit and the memory are coupled before the image scaler and stretcher circuit, wherein when the resolution of the driven panel is increased, the memory used by the apparatus is not increased in a mathematical proportion so as to save the used quantity of the memory and save the required bandwidth of the memory. Therefore, the apparatus has the advantages of flexibility of being used in accordance with different panel resolutions. Further, the apparatus for controlling the LCD uses the smaller memory, so as to reduce the cost of the apparatus and the power consumption of the memory, and reduce the possibility of increasing the operating temperature of the apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for controlling a liquid crystal display (LCD), comprising:
a memory, for storing a first frame data;
an image scaler circuit, for receiving a second frame and shrinking the second frame data;
a liquid crystal accelerating circuit, coupled to the image scaler circuit and the memory, for comparing the first frame data and the second frame data and adjusting pixels of the second frame data, wherein the first frame data stored in the memory is refreshed with the second frame data;
an image stretcher circuit, coupled to the liquid crystal accelerating circuit, for receiving and enlarging adjusted second frame data; and
an interface signal transmitting circuit, coupled to the image stretcher circuit, for receiving the second frame data and transmitting an interface signal to a liquid crystal panel module.

2. The apparatus for controlling the LCD as claimed in claim 1, wherein the interface signal is a low voltage differential signal.

3. The apparatus for controlling the LCD as claimed in claim 1, wherein the interface signal is a low amplitude differential signal.

4. The apparatus for controlling the LCD as claimed in claim 1, further comprising an analog-to-digital interface for receiving and converting an analog image signal into the second frame data, and transmitting the second frame data to the image scaler circuit.

5. The apparatus for controlling the LCD as claimed in claim 1, further comprising a digital video receiving interface for receiving and converting a digital image signal into the second frame data and transmitting the second frame data to the image scaler circuit.

6. The apparatus for controlling the LCD as claimed in claim 1, further comprising a micro-processing unit for controlling the apparatus.

7. The apparatus for controlling the LCD as claimed in claim 6, further comprising a flash memory coupled to the micro-processing unit for storing an access control instruction satisfying the micro-processing unit.

8. The apparatus for controlling the LCD as claimed in claim 1, wherein the apparatus forms a package of an integrated circuit (IC) chip, the package comprises a first die and a second die, wherein the first die comprises the image scaler circuit, the liquid crystal accelerating circuit, the image stretcher circuit, and the interface signal transmitting circuit, and the second die comprises the memory.

9. The apparatus for controlling the LCD as claimed in claim 8, wherein the first die further comprises an analog-to-digital interface for receiving and converting an analog image signal into the second frame data and transmitting the second frame data to the image scaler circuit.

10. The apparatus for controlling the LCD as claimed in claim 8, wherein the first die comprises a digital video receiving interface for receiving and converting a digital image signal into the second frame data and transmitting the second frame data to the image scaler circuit.

11. The apparatus for controlling the LCD as claimed in claim 8, wherein the first die further comprises a micro-processing unit used to control the apparatus.

12. The apparatus for controlling the LCD as claimed in claim 11, wherein the apparatus further comprises a third die including a flash memory coupled to the micro-processing unit for issuing an access control instruction satisfying the micro-processing unit.

13. The apparatus for controlling the LCD as claimed in claim 12, wherein the first die, the second die, and the third die are coupled by stacking or in parallel, so as to form the package.

14. An apparatus for controlling the LCD, comprising:
a memory, for storing a first frame data;
a liquid crystal accelerating circuit, coupled to the memory, for receiving a second frame data, comparing the first frame data and the second frame data, and adjusting pixels of the second frame data, wherein the first frame data stored in the memory is refreshed with the second frame data;
an image scaler and stretcher circuit, coupled to the liquid crystal accelerating circuit, for receiving the adjusted second frame data, and shrinking or enlarging the second frame data; and
an interface signal transmitting circuit, coupled to the image scaler and stretcher circuit, for receiving the second frame data and transmitting an interface signal to a liquid crystal panel module.

15. The apparatus for controlling the LCD as claimed in claim 14, wherein the interface signal is a low voltage differential signal.

16. The apparatus for controlling the LCD as claimed in claim 14, wherein the interface signal is a low amplitude differential signal.

17. The apparatus for controlling the LCD as claimed in claim 14, further comprising an analog-to-digital interface for receiving and converting an analog image signal into the second frame data, and transmitting the second frame data to the liquid crystal accelerating circuit.

18. The apparatus for controlling the LCD as claimed in claim 14, further comprising a digital video receiving interface for receiving and converting a digital image signal into the second frame data, and transmitting the second frame data to the liquid crystal accelerating circuit.

19. The apparatus for controlling the LCD as claimed in claim 14, further comprising a micro-processing unit for controlling the apparatus.

20. The apparatus for controlling the LCD as claimed in claim 19, further comprising a flash memory coupled to the micro-processing unit for storing an access control instruction satisfying the micro-processing unit.

21. The apparatus for controlling the LCD as claimed in claim 14, wherein the apparatus forms a package of an IC chip, the package comprises a first die and a second die, wherein the first die comprises the liquid crystal accelerating circuit, the image scaler and stretcher circuit, and the interface signal transmitting circuit, and the second die comprises the memory.

22. The apparatus for controlling the LCD as claimed in claim 21, wherein the first die comprises an analog-to-digital interface for receiving and converting an analog image signal into the second frame data, and transmitting the second frame data to the image scaler circuit.

23. The apparatus for controlling the LCD as claimed in claim 21, wherein the first die further comprises a digital video receiving interface for receiving and converting a digital image signal into the second frame data, and transmitting the second frame data to the image scaler circuit.

24. The apparatus for controlling the LCD as claimed in claim 21, wherein the first die further comprises a micro-processing unit used to control the apparatus.

25. The apparatus for controlling the LCD as claimed in claim 24, wherein the apparatus further comprises a third die including a flash memory coupled to the micro-processing unit for storing an access control instruction satisfying the micro-processing unit.

26. The apparatus for controlling the LCD as claimed in claim 25, wherein the first die, the second die, and the third die are coupled by stacking or in parallel, so as to form the package.
